(19) United States
(12) Patent Application Publication
(10) Pub. No.: US 2008/0244301 A1
(43) Pub. Date: Oct. 2, 2008

(54) REAL-TIME CLOCK CORRECTION METHODS AND APPARATUS

(75) Inventor: Hung-Kai Shih, Yunlin County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/691,525

(22) Filed: Mar. 27, 2007

(51) Int. Cl. G06F 1/14

(52) U.S. Cl. 713/500

(57) ABSTRACT

A real-time clock (RTC) correction method is provided. Correction data for correcting an RTC of the electronic device is calculated and stored before a power off operation of an electronic device. When the power off operation is performed between two correction operations of the RTC, the period between the two correction operations of the RTC is also calculated. The RTC is corrected utilizing the correction data and the period.

### CROSS REFERENCE TO RELATED APPLICATIONS

This patent application incorporates by reference the entire disclosure in copending U.S. patent application Ser. No. 11/536,981 filed Sep. 29, 2006, assigned to the same assignee as the present invention.

### BACKGROUND OF THE INVENTION

1. Field of the Invention

The invention relates to computer techniques, and more particularly to correction methods and devices for correcting a time value of a real-time clock (RTC).

2. Description of the Related Art

FIG. 1 is a schematic diagram of a conventional device, which controls a real-time clock (RTC). The device 100 controls an RTC 180 and comprises a crystal 110, a second counter 120, a minute counter 130, an hour counter 140, a day counter 150, a year counter 160, and a processor 170. Assume for the purposes of explanation that the frequency generated by the crystal 110 is 32768 Hz.

The second counter 120 counts pulses from the frequency generated by the crystal 110. When the accumulated count of the second counter 120 reaches 32768, the second counter 120 outputs a notification signal to the minute counter 130 for every 32768 pulses of the frequency. Thus, the accumulated count of the minute counter 130 is increased one unit from zero and the second counter 120 terminates a preceding count and begins a new count. When the accumulated count of the minute counter 130 reaches 60, the minute counter 130 outputs a notification signal to the hour counter 140. Thus, the accumulated count of the hour counter 140 is increased one unit from zero and the minute counter 130 terminates a preceding count and begins a new count.

When the accumulated counts of the hour counter 140 reaches 24, the hour counter 140 outputs a notification signal to the day counter 150. Thus, the accumulated count of the day counter 150 is increased one unit from zero and the hour counter 140 terminates a preceding count and begins a new count. When the accumulated count of the day counter 150 reaches a preset value, the day counter 150 outputs a notification signal to the year counter 160. Thus, the accumulated count of the year counter 160 is increased one unit from zero and the day counter 150 terminates a preceding count and begins a new count.

When the accumulated count of the second counter 120, the minute counter 130, the hour counter 140, the day counter 150, or the year counter 160 is changed, the corresponding counter notices a processor 170 for updating the time of a real-time clock (RTC) 180.

The accuracy of the RTC 180 is thus determined by the frequency generated by the crystal 110. The frequency generated by the crystal 110, however, is easily altered by temperature and frequency drift, thus, crystal 110 may generate an incorrect frequency.

The frequency generated by the crystal 110 changes with environmental temperature. The frequency generated by the crystal 110 has a drift error between +20 ppm and −20 ppm due to manufacturing procedures. If the crystal 110 generates an incorrect frequency, the RTC 180 time is incorrect.

RTC 180 may be corrected utilizing various correction schemes. Current RTC correction schemes, however, requires execution by a processor, such as processor 170. Thus, when device 100 as well as the processor therein is powered off, RTC correction is not performed. The rate of error of RTC 180 may increase with length of time the device 100 is powered off.

### BRIEF SUMMARY OF THE INVENTION

Real time clock correction methods and apparatuses are provided. An exemplary embodiment of a real-time clock (RTC) correction method implemented in an electronic device comprises the following steps. Correction data for correcting an RTC of the electronic device is calculated and stored before a power off operation of the electronic device. When the power off operation is performed between two correction operations of the RTC, the period between the two correction operations of the RTC is also calculated. The RTC is corrected utilizing the correction data and the period.

Another exemplary embodiment of a real-time clock (RTC) correction method implemented in an electronic device comprises the following steps. Correction data for correcting an RTC of the electronic device is calculated and stored before a power off operation of the electronic device. In response to a power on operation of the electronic device after the power off operation, the RTC is corrected utilizing the correction data.

Another exemplary embodiment of a real-time clock (RTC) correction method implemented in an electronic device comprises the following steps. One of a plurality of correction schemes for correcting an RTC of the electronic device is activated based on whether a power off operation of the electronic device is performed between two successive RTC corrections. The RTC is corrected utilizing the activated scheme in the last one of the two successive RTC corrections.

An exemplary embodiment of a real-time clock (RTC) correction apparatus comprises an RTC and a processor. The processor calculates and stores correction data for correcting the RTC before a power off operation of the apparatus. When the power off operation is performed between two correction operations of the RTC, the period between the two operations is calculated. The RTC is then corrected utilizing the correction data and the period.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional device;

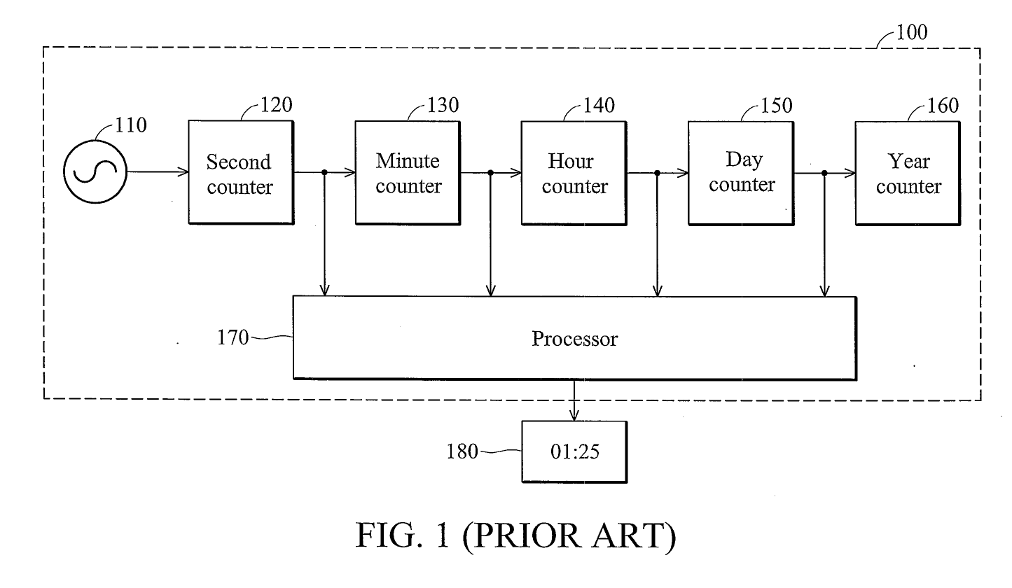

FIG. 2 is a schematic view showing an exemplary embodiment of a real-time clock (RTC) correction apparatus;

FIG. 3 is a flowchart showing an exemplary embodiment of an RTC correction method;

FIG. 4 is a schematic view showing operation of an exemplary embodiment of a real-time clock (RTC) correction apparatus with reference to a timeline;

FIG. 5 is a flowchart showing an exemplary embodiment of a power on calibration; and

FIG. 6 is a flowchart showing an exemplary embodiment of an RTC correction method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Real-time clock (RTC) correction methods can be implemented in various devices with an RTC, such as a mobile phone. An exemplary embodiment of a device executing a real-time clock (RTC) correction method is given in the following.

### RTC Correction Apparatus

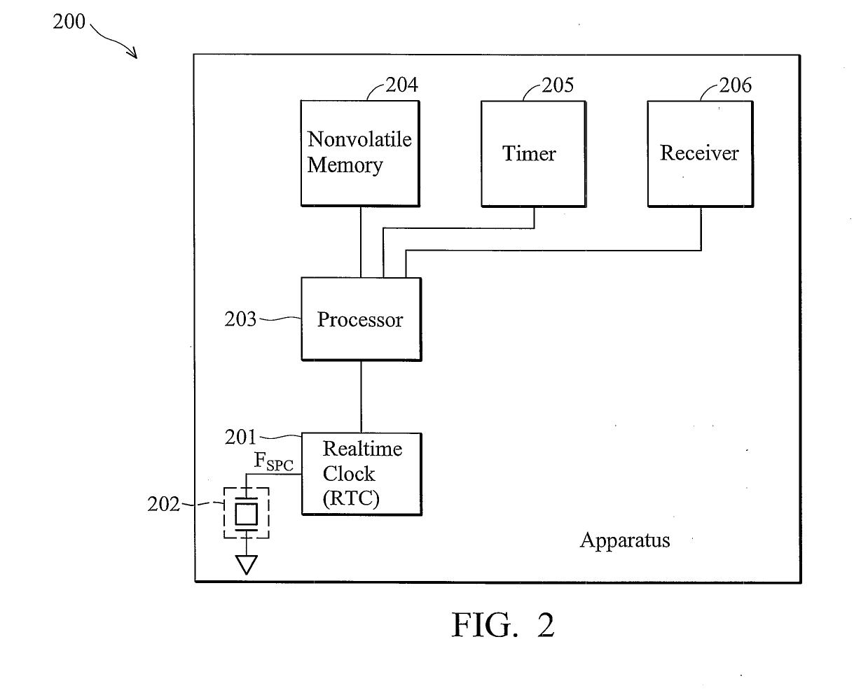

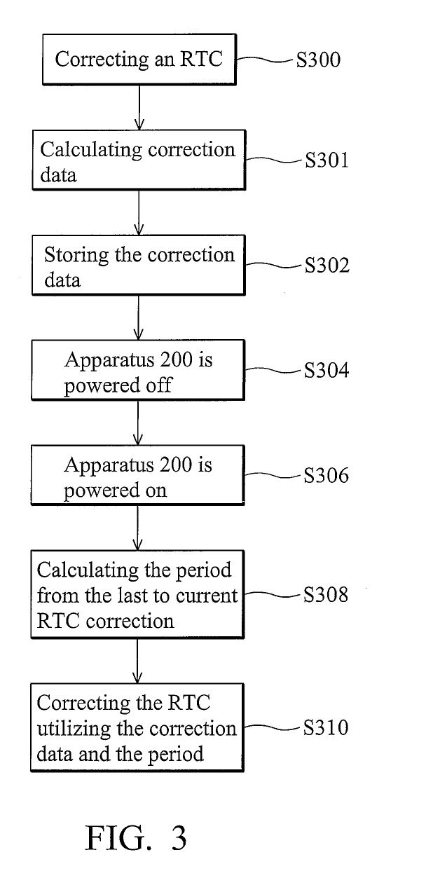

With reference to FIG. 2, real-time clock (RTC) correction apparatus 200 comprises RTC 201, processor 203, nonvolatile memory 204, timer 205, and receiver 206. Receiver 206 may comprise an antenna, a network interface card, or any other communication device for receiving external time references. Timer 205 may be implemented by circuits of computer programs. The frequency generator 202 is a crystal for generating a specific clock F_{SPC}. The RTC 201 provides time values according to the specific clock F_{SPC}. Because the specific clock F_{SPC} may not be accurate enough, the time value provided by the RTC 201 may be inaccurate. Thus, processor 203 may correct RTC 201. FIG. 3 shows RTC correction operations.

### RTC Correction Method

With reference to FIG. 3, processor 203 calculates correction data to correct RTC 201 before a power off operation of the apparatus 200 (steps S300 and S301). For example, the correction data comprises the error value of RTC 201 over an RTC error measurement period. Processor 203 stores the correction data in a nonvolatile memory, such as nonvolatile memory 204 (step S302). Apparatus 200 is powered off (step S304). When apparatus 200 is powered on after the power off (step S306), processor 203 calculates the period between the last correction operation of RTC 201 in step S301 and the current RTC 201 correction operation (step S308). RTC 201 is then corrected utilizing the correction data and the period (step S310). The second correction operation of RTC 201 in step S310 may be automatically initiated in response to the power on operation of apparatus 200.

### Exemplary RTC Corrections

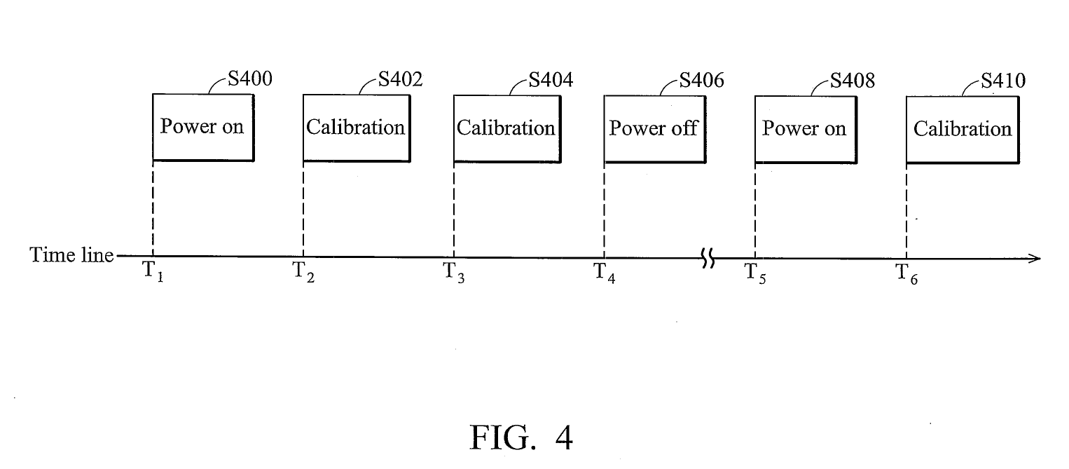

For example, with reference to FIG. 4, time values on the timeline may be labeled to represent power on/off of device 200 and expiration of timer 205. When apparatus 200 is powered on in T1 (step S400), processor 203 resets timer 205 for keeping a preset period of time by signifying expiration thereof, and records time value TV1 and time reference index F1 derived from external time reference received by receiver 206 from an external device, such as a satellite, a base station, or a computer server. The preset period, for example, may be one hour, 30 minutes, 20 minutes or any time length. For example, the time reference index may be a count of frames received from a base station. A frame is equal to 6/130 seconds (=4.615 seconds). Alternatively, time reference index may be a time value more accurate than that of RTC 201.

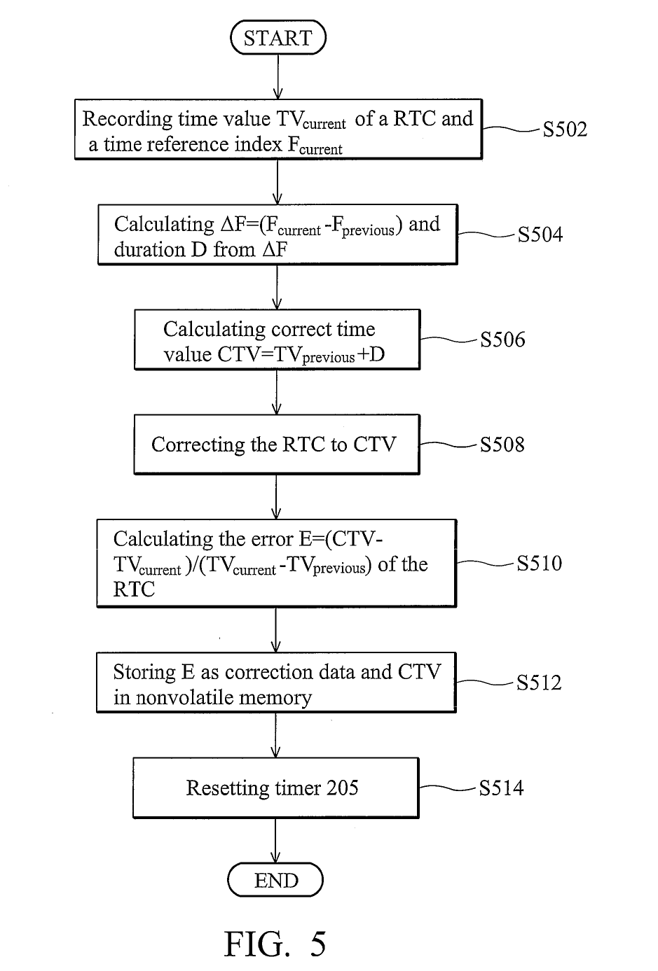

When timer 205 expires in T2, processor 203 performs power on calibration detailed with reference to FIG. 5. In a power on calibration, processor 203 records time value TV_{current} of RTC 201 and an index F_{current} of external time reference received by receiver 206 (step S502) and calculates ΔF=(F_{current}−Fₚᵣₑᵥᵢₒᵤₛ) and the duration D from ΔF (step S504), where Fₚᵣₑᵥᵢₒᵤₛ is the time reference index previously recorded by device 200. Fₚᵣₑᵥᵢₒᵤₛ may be derived by processor 203 from external time reference received by receiver 206 in response to previous expiration of timer 205 or power on of device 200. Processor 203 calculates correct time value CTV=TVₚᵣₑᵥᵢₒᵤₛ+D in response to the expiration of timer 205 (step S506) and corrects RTC 201 to the correct time value CTV (step S508). Further, processor 203 calculates the error E=(CTV−TV_{current})/(TV_{current}−TVₚᵣₑᵥᵢₒᵤₛ) of RTC 201 (step S10), where TVₚᵣₑᵥᵢₒᵤₛ may be the corrected or uncorrected time value of RTC 201 previously recorded by device 200. TVₚᵣₑᵥᵢₒᵤₛ may be retrieved and recorded by processor 203 in response to previous expiration of timer 205 or power on of device 200. Processor 203 stores the error E as the correction data and the correct time value CTV in nonvolatile memory 204 (step S512), and resets timer 205 (step S514). Thus, RTC correction and RTC error estimation are both included in a calibration.

Processor 203 performs step S402 in response to the expiration of timer 205 at time point T2. In step S402, processor 203 records time value TV2 of RTC 201 and index F2 derived from time reference received by receiver 206 and calculates ΔF=(F2−F1) and the duration D1 from ΔF (step S402). Processor 203 further calculates correct time value CTV2=TV1+D1 at time point T2 and utilizes the correct time value CTV2 to correct RTC 201. Processor 203 may calculate the error E=(CTV2−TV2)/(TV2−TV1) of RTC 201, stores the error E as the correction data and the correct time value CTV2 in nonvolatile memory 204, and resets timer 205.

Processor 203 performs step S404 in response to another expiration of timer 205 at time point T3. Similarly, in step S404, processor 203 records time value TV3 of RTC 201 and index F3 derived from time reference received by receiver 206 and calculates ΔF=(F3−F2) and the duration D2 from ΔF (step S402). Processor 203 further calculates correct time value CTV3=CTV2+D2 at time point T3 and corrects time value of RTC 201 to CTV3. Processor 203 may calculate the error E=(CTV3−TV3)/(TV3−TV2) of RTC 201, stores the error E as the correction data and the correct time value CTV3 in nonvolatile memory 204, and resets timer 205.

Device 200 is powered off at time point T4 and powered on at T5. An RTC correction may be automatically initiated as soon as apparatus 200 is powered on. In response to a power on operation of apparatus 200, processor 203 utilizes another RTC correction scheme to correct RTC 201, according to which processor 203 retrieves time value TV5 of RTC 201 at T5, calculates the period (TV5−CTV3) between the previous RTC correction operation at T3 and current RTC correction operation at T5, utilizes error E=(CTV3−TV3)/(TV3−TV2) stored in memory 204 to calculate estimated error E×(TV5−CTV3) of RTC 201 during the period, and corrects RTC 203 to CTV5=TV5+E×(TV5−CTV3). Note that the RTC correction utilizes last correction data E in memory 204 rather than time reference. Thus, when frame count is utilized as time reference, even if frame counting is stopped during T4 to T5, RTC 201 can be corrected utilizing last correction data E in memory 204.

Following powering on of apparatus 200, processor 203 may execute periodic calibrations. For example, processor 203 performs step S410 in response to the expiration of timer 205 at time point T2. In step S410, processor 203 records time value TV6 of RTC 201 and index F6 derived from time reference received by receiver 206 and calculates ΔF=(F6−F5) and the duration D5 from ΔF, where F5 is derived from time reference received by receiver 206 at T5. Processor 203 further calculates correct time value CTV6=CTV5+D5 at time point T6 and utilizes the correct time value CTV6 to correct RTC 201. Processor 203 may calculate the error E=(CTV6−TV6)/(TV6−TV5) of RTC 201, store the error E as the correction data and the correct time value CTV6 in nonvolatile memory 204, and resets timer 205.

### Use of Various RTC Correction Schemes

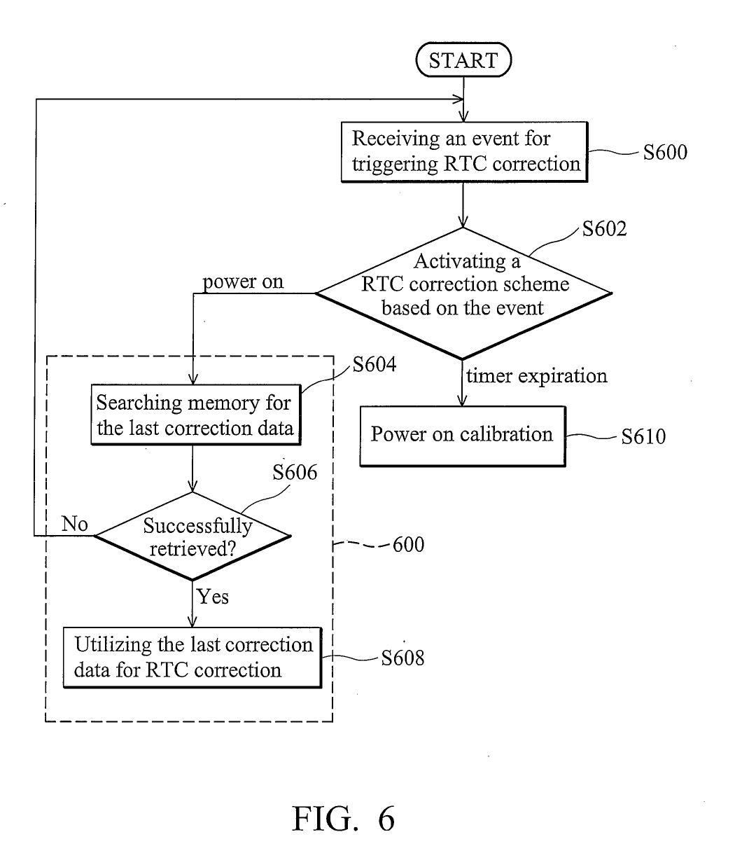

With reference to FIG. 6, processor 203 receives and identifies an event for triggering RTC correction (step S600) and activates an appropriate RTC correction scheme based on the event (step S602). When receiving an expiration event of timer 205, processor 203 performs a power on calibration to correct RTC 201 (step S610). When receiving a power on event of apparatus 200, it is determined that a power off operation of apparatus 200 occurred prior to the triggered current RTC correction, and the correction is intended to compensate the inaccuracy of RTC 201 during the period when apparatus 200 is off. Processor 203 accordingly searches nonvolatile memory 204 for the last correction data for correcting RTC 201 (step S604) and determines if the last correction data is successfully retrieved therefrom (step S606). If not, the workflow returns to step S600. Thus, RTC correction is delayed until the next power on calibration is performed to correct RTC 201. If so, the last correction data is utilized to correct RTC 201 as previously described (step S608).

Absence of the last correction data in nonvolatile memory 204 implies the no calibration has been performed before the power on event, or in other words, no power off operation of apparatus 200 has been performed between the two successive RTC correction operations. The two successive RTC correction operations represent the current RTC correction triggered by the event in step S600 and a previous RTC correction prior to the current RTC correction. When the last correction data is successfully retrieved from nonvolatile memory 204, it is determined that at least a calibration is performed before the power off and power on events, thus, correction data generated in the calibration can be utilized in the current RTC correction.

Note that another RTC correction scheme may be execution in substitution for the calibration in step S610. For example, a correction register may be utilized to correct a second counter in RTC 201.

### Variations

With reference to FIG. 4, automatic RTC correction responsive to the power on event of apparatus 200 in T5 may be disabled in some embodiments. RTC correction at T6 may be modified as the following. Processor 203 retrieves time value TV6 of RTC 201 at T6, calculates the period (TV6−CTV3) between the previous RTC correction operation at T3 and current RTC correction operation at T6, utilizes error E=(CTV3−TV3)/(TV3−TV2) stored in memory 204 to calculate estimated error E×(TV6−CTV3) of RTC 201 during the period, and corrects RTC 203 to TV6+E×(TV6−CTV3). The interval between T5 and T6 may be adjusted and, for example, kept by timer 205 or another timer.

Apparatus 200 may comprise a mobile phone, a personal digital assistant (PDA), a notebook computer, a tablet personal computer (PC), or any other device capable of program execution. Apparatus 200 may comprise a display for showing time values of RTC 201.

Receiver 206 may comprise a communication device receiving and transmitting data through a cabled or wireless communication channel. The communication device may comprise infrared, radio frequency (RF), Bluetooth, or other transceiver. Additionally, when a content provider or a consumer terminal is embodied in a mobile phone, the communication device can be a cellular MODEM unit, such as a GSM/GPRS or W-CDMA communication module, which communicates with the cellular network in compliance with the Wireless Application Protocol (WAP), GSM/GPRS or W-CDMA standards.

Nonvolatile memory 204 may comprise flash memory, a hard disk, or other memory. Processor 203 may comprise a central processing unit (CPU) of apparatus 200 or a chip dedicated for RTC correction. RTC correction methods may be implemented by circuits or computer programs.

Error E=(CTV−TV_{current})/(TV_{current}−TVₚᵣₑᵥᵢₒᵤₛ) of RTC 201 may be altered to E=(CTV−TV_{current})/(TV_{current}−CTVₚᵣₑᵥᵢₒᵤₛ), where CTVₚᵣₑᵥᵢₒᵤₛ is the correction time value generated in the last RTC correction operation. For example, error E=(CTV3−TV3)/(TV3−TV2) of RTC 201 in T3 may be altered to E=(CTV3−TV3)/(TV3−CTV2).

### CONCLUSION

In conclusion, the RTC correction method receives events for triggering an RTC correction in an electronic device. One of a plurality of correction schemes is activated for correcting the RTC based on whether a power off operation of the electronic device has occurred between the current RTC correction and a previous RTC correction. The RTC is corrected utilizing the activated scheme of the current RTC correction. When a power off operation of the electronic device is performed between the two successive RTC corrections, a first scheme is performed to correct the RTC utilizing correction data calculated and stored prior to the power off operation. When no power off operation of the electronic device is performed between the two successive RTC corrections, a second scheme is performed to correct the RTC with reference to external time reference received by the electronic device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A real-time clock (RTC) correction method, implemented in an electronic device, comprising:
calculating and storing correction data for correcting an RTC of the electronic device before a power off operation of the electronic device;
when the power off operation is performed between two correction operations of the RTC, calculating the period between the two correction operations of the RTC; and
correcting the RTC utilizing the correction data and the period.

2. The method as claimed in claim 1, wherein the correction data comprises the error value of the RTC over an RTC error measurement period.

3. The method as claimed in claim 2, wherein the period of time for RTC error measurement is before the power off operation.

4. The method as claimed in claim 3, wherein the correction data is generated from the first one of the two correction operations of the RTC.

5. The method as claimed in claim 2, wherein the period between the two correction operations of the RTC is calculated by:
before the power off operation, storing a first time value of the RTC corresponding to the first one of the two correction operations of the RTC;
retrieving a second time value of the RTC corresponding to the second one of the two correction operations of the RTC; and
subtracting the first time value from the second time value.

6. The method as claimed in claim 1, wherein the correction data and the second time value are stored in a nonvolatile memory in the electronic device.

7. The method as claimed in claim 1, wherein the step of correcting the RTC utilizing the correction data and the period is performed in the second one of the two correction operations of the RTC which is automatically initiated in response to a power on operation of the electronic device after the power off operation.

8. A real-time clock (RTC) correction method, implemented in an electronic device, comprising:
calculating and storing correction data for correcting an RTC of the electronic device before a power off operation of the electronic device; and
in response to a power on operation of the electronic device after the power off operation, correcting the RTC utilizing the correction data.

9. The method as claimed in claim 8, wherein the correction data is stored in a nonvolatile memory in the electronic device.

10. The method as claimed in claim 8, wherein the correction data comprises the error value of the RTC over an RTC error measurement period.

11. The method as claimed in claim 10, wherein the period of time for RTC error measurement is before the power off operation.

12. The method as claimed in claim 11, wherein the correction data is generated from the last correction of the RTC before the power off operation.

13. The method as claimed in claim 10, further comprising:
calculating the period between the last correction of the RTC and the power on operation; and
utilizing the period for the correcting step.

14. A real-time clock (RTC) correction method, implemented in an electronic device, comprising:
activating one of a plurality of correction schemes for correcting an RTC of the electronic device based on whether a power off operation of the electronic device is performed between two successive RTC corrections; and
correcting the RTC utilizing the activated scheme in the last one of the two successive RTC corrections.

15. The method as claimed in claim 14, further comprising:
when a power off operation of the electronic device is performed between the two successive RTC corrections, utilizing a first correction scheme to correct the RTC; and
when no power off operation of the electronic device is performed between the two successive RTC corrections, utilizing a second correction scheme different from the first correction scheme to correct the RTC.

16. The method as claimed in claim 15, further comprising:
in the first correction scheme, correcting the RTC utilizing correction data calculated and stored prior to the power off operation.

17. The method as claimed in claim 16, further comprising:
in the second correction scheme, correcting the RTC with reference to external time reference received by the electronic device.

18. A real-time clock (RTC) correction apparatus comprising:
an RTC; and
a processor calculating and storing correction data for correcting the RTC before a power off operation of the apparatus, when the power off operation is performed between two correction operations of the RTC, calculating the period between the two correction operations of the RTC, and correcting the RTC utilizing the correction data and the period.

19. The apparatus as claimed in claim 18, wherein the correction data comprises the error value of the RTC over an RTC error measurement period.

20. The apparatus as claimed in claim 19, wherein the processor generates the correction data in the first one of the two correction operations of the RTC.

21. The apparatus as claimed in claim 19, wherein the processor calculates the period between the two correction operations of the RTC by storing a first time value of the RTC corresponding to the first one of the two correction operations of the RTC, retrieving a second time value of the RTC corresponding to the second one of the two correction operations of the RTC, and subtracting the first time value from the second time value.

22. The apparatus as claimed in claim 21, further comprising:
a nonvolatile memory storing the correction data and the second time value.

23. The apparatus as claimed in claim 18, wherein the processor corrects the RTC utilizing the correction data and the period in the second one of the two correction operations of the RTC which is automatically initiated in response to a power on operation of the apparatus after the power off operation.

24. The apparatus as claimed in claim 18, wherein the apparatus comprises a mobile phone.
